(19) United States
(12) Patent Application Publication
(10) Pub. No.: US 2014/0379328 A1
(43) Pub. Date: Dec. 25, 2014

(54) APPARATUS AND METHOD FOR OUTPUTTING IMAGE ACCORDING TO TEXT INPUT IN REAL TIME

(71) Applicant: Electronics and Telecommunications Research Institute, Daejeon (KR)

(72) Inventors: Jae-Young KIM, Daegu (KR); Hyung-Soo LEE, Daegu (KR); Kee-Koo KWON, Daegu (KR); Soo-In LEE, Daejeon (KR)

(73) Assignee: Electronics and Telecommunications Research Institute, Daejeon (KR)

(21) Appl. No.: 14/295,244

(22) Filed: Jun. 3, 2014

(30) Foreign Application Priority Data
Jun. 24, 2013 (KR) 10-2013-0072735

(51) Int. Cl. G06F 17/21

(52) U.S. Cl. CPC G06F 17/21
USPC 704/9

(57) ABSTRACT

An apparatus and method for outputting an image according to text input in real time are provided. The apparatus for outputting an image in real time includes: a text receiving unit configured to extract unit text from input text; a syntax analyzing unit configured to analyze syntax of the unit text to generate state information corresponding to the unit text; a text reference database (DB) matching unit configured to search a reference DB to generate an image corresponding to the state information; a change necessity determining unit configured to determine whether an image corresponding to previous unit text needs to be changed; and an output unit configured to generate an output image by using any one or more of the image corresponding to the state information and the image corresponding to the previous unit text according to the necessity for the change.

### CROSS-REFERENCE TO RELATED APPLICATION

This application claims the benefit of Korean Patent Application No. 10-2013-0072735 filed on Jun. 24, 2013, with the Korean Intellectual Property Office, the disclosure of which is incorporated herein by reference.

### BACKGROUND OF THE INVENTION

1. Technical Field

The present invention relates to a technique of outputting an image matched to text, and more particularly, to an apparatus and method for outputting an image such as a drawing, animation, or the like, to a screen according to input text.

2. Description of the Related Art

In line with the development of communications technology and enhancement of functions of portable terminals, a short message service (SMS) allowing for exchanging short messages between users has been widely used

Recently, due to advantages of incurring low cost over voice call, SMS tends to be favored, relative to a voice call function, and multimedia message system (MM) supporting video, photo images, music files, and the like, beyond simple text-based data, have been frequently used by portable terminal users overseas as well as domestically, as a typical wired/wireless integrated service combining advantages of SMS and e-male service.

Existing methods of expressing a text message sender's feeling, mood, or the like, include a method of sensing a dynamic message by using a multimedia message and a method of using emoticon formed by combining special characteristics provided in portable terminals, or the like. Emoticon has been widely used in cyber space in that anyone can understand it easily and it easily expresses user's subtle feelings, and actually, various facial expressions have been developed by chatting service users to end up with various emoticons stored in mobile communication terminals.

However, even with these methods, it is not easy to precisely express various feelings of users in sending text-based data, and emotional expression using emoticon, or the like, may not be given until when text input in units of semantics is completed.

Related art is Korean Patent Laid-Open Publication No. 2011-0110391. This document relates a technique of extracting a feeling state from microblog text and mapping the extracted feeling state to an avatar expression. This technique, however, also allows users to express his or her feeling through an avatar only after text input in units of semantics is completed.

Thus, a technique of outputting an image in real time according to a new text input allowing users to express his or her feelings appropriately in the course of inputting text is urgently required.

### SUMMARY OF THE INVENTION

The present invention provides an apparatus and method for outputting an image according to text input in real time, capable of continuously outputting an intermediate picture or animation in real time according to a text input or change to thus relieve the monotony until the completion of text input and providing a high quality image by using an intermediate picture or animation.

The present invention also provides an apparatus and method for outputting an image according to text input in real time, capable of expressing various user feelings or behaviors through effective real-time image display by determining whether to change, add, and delete an image appropriately based on an already displayed image and results of analyzing syntax corresponding to subsequently input text.

In an aspect, an apparatus for outputting an image in real time may include: a text receiving unit configured to extract unit text from input text; a syntax analyzing unit configured to analyze syntax of the unit text to generate state information corresponding to the unit text; a text reference database (DB) matching unit configured to search a reference DB to generate an image corresponding to the state information; a change necessity determining unit configured to determine whether an image corresponding to previous unit text needs to be changed; and an output unit configured to generate an output image by using any one or more of the image corresponding to the state information and the image corresponding to the previous unit text according to the necessity for the change.

The text receiving unit may continuously extract the unit text while the text is being continuously input.

The image and the output image may each be any one of picture and animation.

The change necessity determining unit may determine any one or more of whether to correct the image corresponding to the previous unit text, whether to add the image corresponding to the state information to the image corresponding to the previous unit text, and whether to delete the image corresponding to the previous unit text.

The change necessity determining unit may determine any one or more of whether to correct the image corresponding to the previous unit text, whether to add the image corresponding to the state information to the image corresponding to the previous unit text, and whether to delete the image corresponding to the previous unit text, according to a correlation between the state information corresponding to the unit text and the state information corresponding to the previous unit text.

When the correlation between the state information corresponding to the unit text and the state information corresponding to the previous unit text is greater than a pre-set value, the change necessity determining unit may determine that the image corresponding to the previous unit text needs to be corrected, and when the correlation is smaller than the pre-set value, the change necessity determining unit may determine that the image corresponding to the state information needs to be added to the image corresponding to the previous unit text.

In a state in which a plurality of images are displayed, when the correlation is smaller than a pre-set lower limit value, the change necessity determining unit may delete an image having a smallest correlation.

The output image may include the image corresponding to the state information as is, or may be an image generated by using the image corresponding to the state information.

In another aspect, a method for outputting an image in real time may include: extracting unit text from input text; analyzing syntax of the unit text to generate state information corresponding to the unit text; searching a reference database (DB) to generate an image corresponding to the state information; determining whether an image corresponding to previous unit text needs to be changed; and generating an output image by using any one or more of the image corresponding to the state information and the image corresponding to the previous unit text according to the necessity for the change.

According to embodiments of the present invention, since an intermediate picture or animation is continuously output in real time according to a text input or change, the monotony until the completion of text input may be relieved, and a high quality image may be provided by using an intermediate picture or animation.

Also, by determining whether to change, add, and delete an image based on an already displayed image and results of analyzing syntax corresponding to subsequently input text, various user feelings or behaviors may be expressed through effective real-time image display.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a real-time image outputting apparatus according to an embodiment of the present invention;

FIG. 2 is a block diagram illustrating an example of a change necessity determining unit illustrated in FIG. 1;

FIG. 3 is a flow chart illustrating a real-time image outputting method according to an embodiment of the present invention;

FIG. 4 is a view illustrating an example of a real-time image output screen in the course of text input;

FIG. 5 is a view illustrating another example of a real-time image output screen in the course of text input.

FIG. 6 is an embodiment of the present invention implemented in a computer system.

### DESCRIPTION OF THE PREFERRED EMBODIMENTS

The present invention will be described in detail below with reference to the accompanying drawings. Repeated descriptions and descriptions of known functions and constructions which have been deemed to make the gist of the present invention unnecessarily vague will be omitted below. The embodiments of the present invention are provided in order to fully describe the present invention to a person having ordinary knowledge in the art. Accordingly, the shapes, sizes, etc. of elements in the drawings may be exaggerated to make the description clear.

Exemplary embodiments of the present invention will be described in detail below with reference to the accompanying drawings.

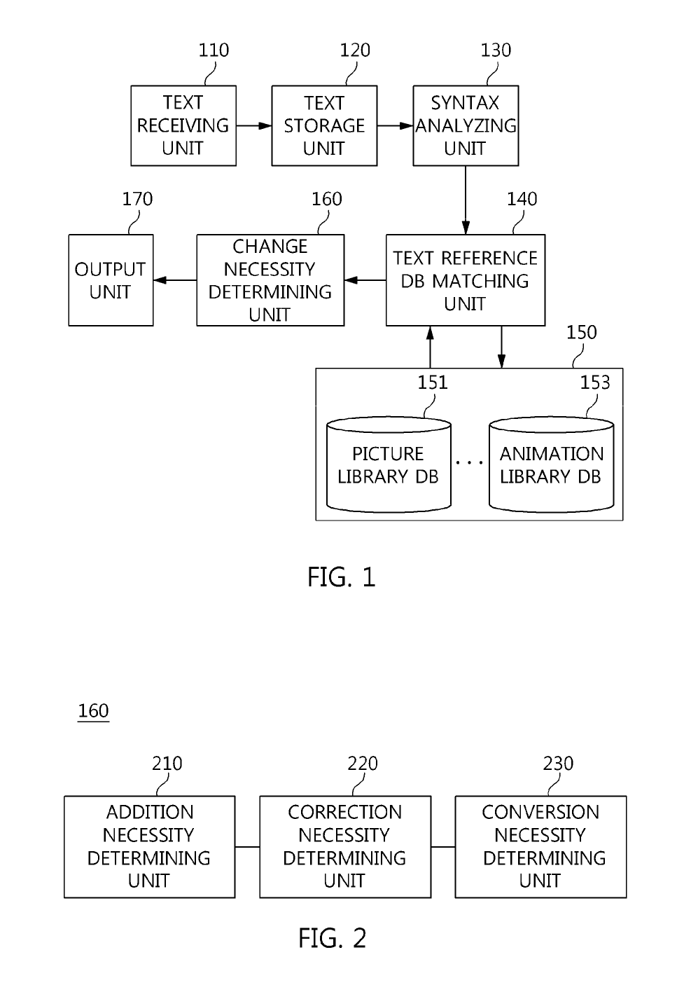

FIG. 1 is a block diagram illustrating a real-time image outputting apparatus according to an embodiment of the present invention.

Referring to FIG. 1, an apparatus for outputting an image in real time according to an embodiment of the present invention includes a text receiving unit 110, a text storage unit 120, a syntax analyzing unit 130, a text reference database (DB) matching unit 140, a reference DB 150, a change necessity determining unit 160, and an output unit 170.

The text receiving unit 110 extracts unit text from input text. In this case, the unit text may be text split by a word delimiter such as a space, enter, tab, an input end character, and the like. In this case, the text receiving unit 110 may continuously extract unit text while text is being continuously input. Namely, as text input continues, the text receiving unit 110 may increasingly extract more unit text.

For example, a user may start to input text to a text input window. While inputting text, when the user inputs the space character, the text receiving unit 110 extracts unit text. While continuously inputting text, when the user inputs the enter character, the text receiving unit 120 may extract next unit text. In this manner, the text receiving unit 110 may extract unit text in real time, while the user is inputting text.

The text storage unit 120 stores unit texts extracted by the text receiving unit 110.

The syntax analyzing unit 130 analyzes syntax of unit text to generate state information corresponding to unit text.

In this case, the state information may be user emotional state information or operational state information. In this case, the syntax analyzing unit 130 may extract an object corresponding to a subject of an emotion or state, or a state of a feeling, an operation, of the like, of the object.

As for specific operations of generating state information corresponding to unit text through syntax analysis by the syntax analyzing unit 130, various techniques known in the art such as in Korean Patent Laid-Open Publication No. 2004-0028038, and the like, may be used.

The text reference DB matching unit 140 searches the reference DB 150 and generates an image corresponding to the state information.

In this case, the image may be a picture or animation.

The reference DB 150 may include a picture library DB 151 storing pictures corresponding various user states and an animation library DB 153 storing animations corresponding to various user states.

As for specific operations of matching state information to a picture or animation of the DB 150 by the text reference DB matching unit 140, various techniques such as pattern matching, or the like, known in the art may be used.

The change necessity determining unit 160 may determine whether an image corresponding to a previous unit text needs to be changed.

Namely, as inputting of text continues, the change necessity determining unit 160 determines whether an image already displayed to the user needs to be added, changed, or deleted through a display unit, so that an image with respect to continuously input text needs to be updated.

For example, when an image corresponding to previous unit text and an image corresponding to results of analyzing syntax of corresponding unit text are identical, the change necessity determining unit 160 may determine that the already displayed image needs not be changed.

For example, when the image corresponding to previous unit text and the image corresponding to results of analyzing syntax of corresponding unit text are different, the change necessity determining unit 160 may replace the already displayed image or add a new image to the already displayed image based on correlation between the two images.

In this case, the change necessity determining unit 160 may determine any one or more of whether to correct the image corresponding to the previous unit text, whether to add an image corresponding to the state information to the image corresponding to the previous unit text, and whether to delete the image corresponding to the previous unit text.

In this case, the change necessity determining unit 160 may determine any one or more of whether to correct the image corresponding to the previous unit text, whether to add an image corresponding to the state information to the image corresponding to the previous unit text, and whether to delete the image corresponding to the previous unit text, according to correlation between the state information corresponding to the unit text and the state information corresponding to the previous unit text.

In this case, when the correlation between the state information corresponding to the unit text and the state information corresponding to the previous unit text is greater than a pre-set value, the change necessity determining unit 160 may determine that the image corresponding to the previous unit text needs to be corrected, and when the correlation is smaller than the pre-set value, the change necessity determining unit 160 may determine that the image corresponding to the state information needs to be added to the image corresponding to the previous unit text.

The correlation may be calculated with respect to each unit text in advance and stored in the reference DB 150.

Namely, in a case in which a state corresponding to the syntax analysis results with respect to the corresponding unit text is closely related to the previous state, it may be determined that an image needs to be corrected such that an already displayed image is replaced with a new image, rather than adding a new image to the already displayed image. Also, in a case in which the state corresponding to the syntax analysis results with respect to the corresponding unit text is not closely related to the previous state, it may be better to display a new image together with the previous image, rather than correcting the already displayed image, in order to prevent loss of information.

In this case, in a state in which a plurality of images are displayed, when the correlation is smaller than a pre-set lower limit, the change necessity determining unit 160 may delete an image having the lowest correlation among the plurality of images.

Namely, in a case in which correlation between a newly added image and an existing displayed image is not high, it may be considered that the state has been significantly changed so previous information is not required and new information is likely to be important, and thus, deletion of the image having the lowest correlation among the previously displayed images may does not cause a problem in expressing a state of an object.

The output unit 170 generates an output image by using any one or more of the image corresponding to the state information and the image corresponding to the previous unit text according to the necessity of the change.

In this case, the output image may include the image corresponding to the state information as is or may be an image generated by using the image corresponding to the state information.

FIG. 2 is a block diagram illustrating an example of a change necessity determining unit illustrated in FIG. 1.

Referring to FIG. 2, the change necessity determining unit 160 illustrated in FIG. 1 includes an addition necessity determining unit 210, a correction necessity determining unit 220, and a conversion necessity determining unit 230.

The addition necessity determining unit 210 determines whether to add an image corresponding to current state information to an image corresponding to previous unit text.

The correction necessity determining unit 220 determines whether to correct the image corresponding to the previous unit text.

The conversion necessity determining unit 230 determines whether to delete a previously displayed image or convert an image format. Namely, the conversion necessity determining unit 230 may delete a portion of a plurality of previously displayed images or may display animation in a state in which a previous picture is displayed.

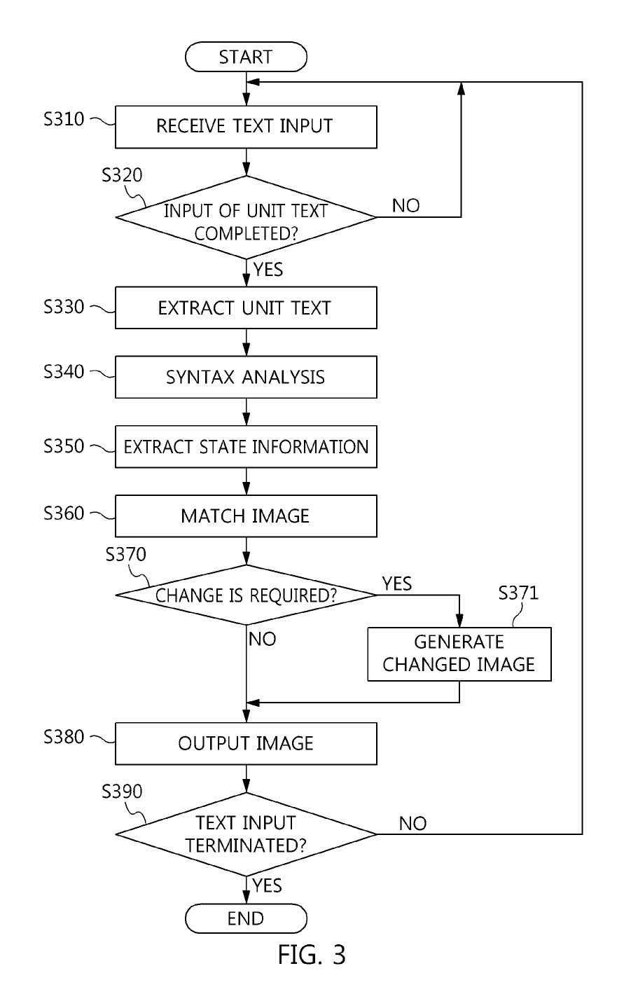

FIG. 3 is a flow chart illustrating a real-time image outputting method according to an embodiment of the present invention.

Referring to FIG. 3, in the real-time image outputting method according to an embodiment of the present invention, a text input is received through an input device (S310).

Also, in the real-time image outputting method according to an embodiment of the present invention, a word delimiter is extracted from the input text to determine whether a unit text input has been completed (S320).

When it is determined that the unit text input has not been completed in operation S320, in the real-time image outputting method according to an embodiment of the present invention, the process is returned to operation S310 and a text input is received.

When it is determined that the unit text input has been completed in operation S320, a unit text is extracted and stored (S330).

In this case, in operation S330, the unit text may be extracted continuously while inputting of text continues.

Also, in the real-time image outputting method according to an embodiment of the present invention, syntax of the extracted unit text is analyzed (S340).

Also, in the real-time image outputting method according to an embodiment of the present invention, state information corresponding to the unit text is extracted by using the syntax analysis results (S350).

Also, in the real-time image outputting method according to an embodiment of the present invention, an image corresponding to the state information is generated by searching a reference DB (S360).

In this case, the image may be any one of a picture and animation.

Also, in the real-time image outputting method according to an embodiment of the present invention, it is determined whether an image corresponding to the previous unit text needs to be changed (S370).

In this case, the image corresponding to previous text may be any one of picture and animation.

In this case, in operation S370, anyone or more of whether to correct the image corresponding to the previous unit text, whether to add an image corresponding to the state information to the image corresponding to the previous unit text, and whether to delete the image corresponding to the previous unit text may be determined.

In this case, in operation S370, anyone or more of whether to correct the image corresponding to the previous unit text, whether to add an image corresponding to the state information to the image corresponding to the previous unit text, and whether to delete the image corresponding to the previous unit text may be determined, according to correlation between the state information corresponding to the unit text and the state information corresponding to the previous unit text.

In this case, in operation S370, when the correlation between the state information corresponding to the unit text and the state information corresponding to the previous unit text is greater than a pre-set value, it may be determined that the image corresponding to the previous unit text needs to be corrected, and when the correlation is smaller than the pre-set value, it may be determined that the image corresponding to the state information

In the operation S370, in a state in which a plurality of images are displayed, when the correlation is smaller than a pre-set lower limit, an image having the lowest correlation among the plurality of images may be deleted.

In operation S370, when it is determined that the image corresponding to the previous unit text needs not to be changed, the image corresponding to the previous unit text may be output as an output image (S380).

In operation S370, when it is determined that the image corresponding to the previous unit text needs to be changed, a process of changing the image corresponding to the previous unit text is performed to generate a changed image (S371), and the changed image is output as an output image (S380).

In this case, the change process may be correction, addition, deletion, or conversion of the image.

In this case, the output image may include the image corresponding to the state information as is or may be an image generated by using the image corresponding to the state information.

When outputting of the image is completed in operation S380, in the real-time image outputting method according to an embodiment of the present invention, it is determined whether text input is terminated by determining whether finally input text is end text (S390).

When it is determined that the text input has not been terminated in operation S390, in the real-time image outputting method according to an embodiment of the present invention, the process is returned to operation S310 and a text input is received.

When it is determined that the text input has been terminated in operation S390, the operation of the real-time image outputting method according to an embodiment of the present invention is terminated.

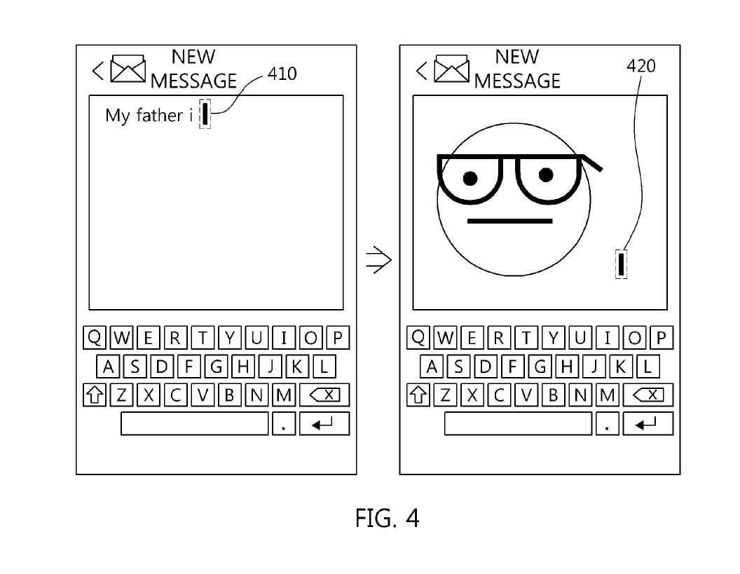

FIG. 4 is a view illustrating an example of a real-time image output screen in the course of text input.

Referring to FIG. 4, it can be seen that a text string “My father I” is input to a text input window. Since a space character “ ” is input after “My”, “My” may be extracted as unit text. In the example illustrated in FIG. 4, state information corresponding to “My” is not generated, so an image corresponding to “My” is not displayed.

Thereafter, since a space character “ ” is input after “father”, “father” may be extracted as unit text. In this case, “father” may be matched to one of images stored in the picture library DB through syntax analysis. According to an embodiment, “My father” obtained by adding unit text “My” not displayed as an image and “father” may be matched to an image illustrated in FIG. 4.

Since text is continuously input, cursors 410 and 420 may be continuously displayed on the text input window.

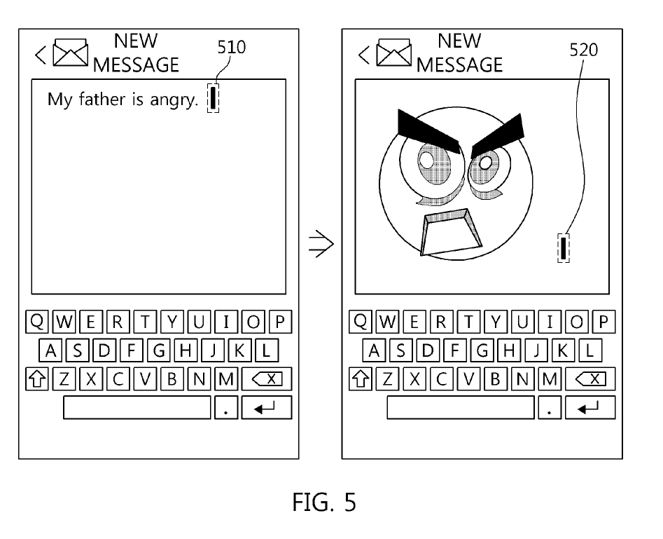

FIG. 5 is a view illustrating another example of a real-time image output screen in the course of text input.

Referring to FIG. 5, it can be seen that text is additionally input to the text window in the state illustrated in FIG. 4 and a text string “My father is angry” is being input. Through the unit text extracting process as described above with reference to FIG. 4, “is” and “angry” may be extracted as unit text. In the example illustrated in FIG. 5, state information corresponding to “is” is not generated, so an image corresponding to “is” is not displayed.

Thereafter, since a space character “ ” is input after “angry”, “angry may be extracted as unit text. In this case, “angry” may be matched to one of images stored in the picture library DB through syntax analysis. According to an embodiment, “is angry” obtained by adding unit text “Is” not displayed as an image and “angry” may be matched to an image illustrated in FIG. 5.

In this manner, when a picture (picture corresponding to “angry” of FIG. 5) matched to particular unit text is generated, it is determined whether to correct an already displayed picture, whether to delete the already displayed picture, or whether to add a new picture to the already displayed picture in consideration of correlation with the picture (picture corresponding to “father” in FIG. 4) already displayed during the text input process.

Since “father” and “angry” may be considered as words which do not conflict or words which are closely related, it can be seen that, in the examples illustrated in FIGS. 4 and 5, the already displayed picture has been replaced (corrected) with a new picture.

The state information may include object information. In the examples illustrated in FIGS. 4 and 5, state information corresponding to “father” may correspond to an object of father.

Since text is continuously being input, the cursors 510 and 520 may be continuously displayed in the text input window.

If in the example illustrated in FIG. 4, if a picture corresponding to “full” is displayed and next input text is “empty”, the two words are conflicting words and it may be more rational to display both a picture corresponding to “full” and a picture corresponding to “empty”, rather than replacing the front displayed picture with the rear picture.

According to an embodiment, “father” and “angry” may be considered not closely related, and unlike those illustrated in FIGS. 4 and 5, the picture corresponding to “angry” may be added to the picture corresponding to “father” so as to be displayed. Namely, a correlation value required for determining the necessity for a change may be set to be different according to an application or an environment.

In the text input state illustrated in FIG. 5, when the user deletes “angry” by using a back space key to become the text input state illustrated in FIG. 4, the displayed picture may be changed from the picture illustrated in FIG. 5 to the picture illustrated in FIG. 4.

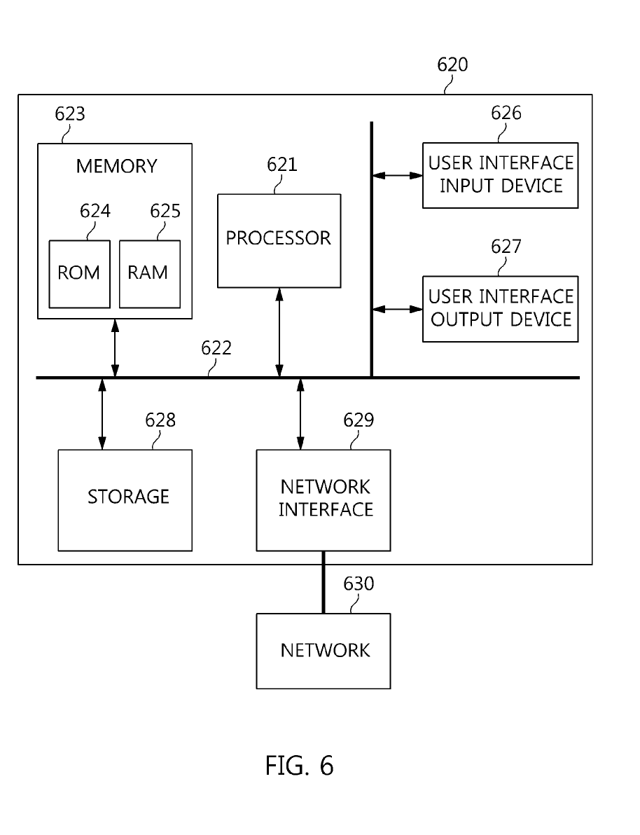

FIG. 6 is an embodiment of the present invention implemented in a computer system.

Referring to FIG. 6, an embodiment of the present invention may be implemented in a computer system, e.g., as a computer readable medium. As shown in in FIG. 6, a computer system 620 may include one or more of a processor 621, a memory 623, a user input device 626, a user output device 627, and a storage 628, each of which communicates through a bus 622. The computer system 620 may also include a network interface 629 that is coupled to a network 630. The processor 621 may be a central processing unit (CPU) or a semiconductor device that executes processing instructions stored in the memory 623 and/or the storage 628. The memory 623 and the storage 628 may include various forms of volatile or non-volatile storage media. For example, the memory may include a read-only memory (ROM) 624 and a random access memory(RAM) 625.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The apparatus and method for outputting an image according to text input in real time according to embodiments of the present invention are not limited in its application of the configurations and methods, but the entirety or a portion of the embodiments can be selectively combined to be configured into various modifications.

What is claimed is:

1. An apparatus for outputting an image in real time, the apparatus comprising:
a text receiving unit configured to extract unit text from input text;
a syntax analyzing unit configured to analyze syntax of the unit text to generate state information corresponding to the unit text;
a text reference database (DB) matching unit configured to search a reference DB to generate an image corresponding to the state information;
a change necessity determining unit configured to determine whether an image corresponding to previous unit text needs to be changed; and
an output unit configured to generate an output image by using any one or more of the image corresponding to the state information and the image corresponding to the previous unit text according to the necessity for the change.

2. The apparatus of claim 1, wherein the text receiving unit continuously extracts the unit text while the text is being continuously input.

3. The apparatus of claim 2, wherein the image and the output image each are any one of picture and animation.

4. The apparatus of claim 3, wherein the change necessity determining unit determines any one or more of whether to correct the image corresponding to the previous unit text, whether to add the image corresponding to the state information to the image corresponding to the previous unit text, and whether to delete the image corresponding to the previous unit text.

5. The apparatus of claim 4, wherein the change necessity determining unit determines any one or more of whether to correct the image corresponding to the previous unit text, whether to add the image corresponding to the state information to the image corresponding to the previous unit text, and whether to delete the image corresponding to the previous unit text, according to a correlation between the state information corresponding to the unit text and the state information corresponding to the previous unit text.

6. The apparatus of claim 5, wherein when the correlation between the state information corresponding to the unit text and the state information corresponding to the previous unit text is greater than a pre-set value, the change necessity determining unit determines that the image corresponding to the previous unit text needs to be corrected, and when the correlation is smaller than the pre-set value, the change necessity determining unit determines that the image corresponding to the state information needs to be added to the image corresponding to the previous unit text.

7. The apparatus of claim 6, wherein in a state in which a plurality of images are displayed, when the correlation is smaller than a pre-set lower limit value, the change necessity determining unit deletes an image having a smallest correlation among the plurality of images.

8. The apparatus of claim 4, wherein the output image includes the image corresponding to the state information as is, or is an image generated by using the image corresponding to the state information.

9. A method for outputting an image in real time, the method comprising:
extracting unit text from input text;
analyzing syntax of the unit text to generate state information corresponding to the unit text;
searching a reference database (DB) to generate an image corresponding to the state information;
determining whether an image corresponding to previous unit text needs to be changed; and
generating an output image by using any one or more of the image corresponding to the state information and the image corresponding to the previous unit text according to the necessity for the change.

10. The method of claim 9, wherein, in the extracting of the unit text, the unit text is continuously extracted while inputting of the text continues.

11. The method of claim 10, wherein the image and the output image each are any one of picture and animation.

12. The method of claim 11, wherein, in the determining whether an image corresponding to previous unit text needs to be changed, any one or more of whether to correct the image corresponding to the previous unit text, whether to add the image corresponding to the state information to the image corresponding to the previous unit text, and whether to delete the image corresponding to the previous unit text is determined.

13. The method of claim 12, wherein, in the determining whether an image corresponding to previous unit text needs to be changed, any one or more of whether to correct the image corresponding to the previous unit text, whether to add the image corresponding to the state information to the image corresponding to the previous unit text, and whether to delete the image corresponding to the previous unit text is determined, according to a correlation between the state information corresponding to the unit text and the state information corresponding to the previous unit text.

14. The method of claim 13, wherein, in the determining whether an image corresponding to previous unit text needs to be changed, when the correlation between the state information corresponding to the unit text and the state information corresponding to the previous unit text is greater than a pre-set value, it is determined that the image corresponding to the previous unit text needs to be corrected, and when the correlation is smaller than the pre-set value, it is determined that the image corresponding to the state information needs to be added to the image corresponding to the previous unit text.

15. The method of claim 14, wherein in the determining whether an image corresponding to previous unit text needs to be changed, in a state in which a plurality of images are displayed, when the correlation is smaller than a pre-set lower limit value, an image having a smallest correlation among the plurality of images is deleted.

16. The method of claim 12, wherein the output image includes the image corresponding to the state information as is, or is an image generated by using the image corresponding to the state information.
